(19) United States
(12) Patent Application Publication
(10) Pub. No.: US 2025/0061721 A1
(43) Pub. Date: Feb. 20, 2025

(54) SURVEILLANCE BY COOPERATIVE COMPUTER VISION

(71) Applicant: Codex Corporation, Maple Grove, MN (US)

(72) Inventors: Supreeth Betigeri, San Francisco, CA (US); Adithi Deborah Chakravarthy, Omaha, NE (US); Vidhey Oza, Maple Grove, MN (US); Adit Modhavdia, Maple Grove, MN (US); Daniel Quam, Sugar Land, TX (US); Abhishek Pandya, Maple Grove, MN (US); Kenneth L. Dalley, JR., Maple Grove, MN (US)

(21) Appl. No.: 18/807,113

(22) Filed: Aug. 16, 2024

Related U.S. Application Data
(60) Provisional application No. 63/533,500, filed on Aug. 18, 2023.

(51) Int. Cl. G06V 20/52; G06V 20/64; G06V 40/16

(52) U.S. Cl. CPC G06V 20/52; G06V 20/64; G06V 40/172; G06V 2201/07

(57) ABSTRACT

Embodiments regard surveillance by cooperative computer vision models.

### PRIORITY APPLICATIONS

This application claims the benefit of priority to U.S. Provisional Application Ser. No. 63/533,500, filed Aug. 18, 2023, the content of which is incorporated by reference in its entirety.

### TECHNICAL FIELD

Embodiments provide improved surveillance of a geographical region. The geographical region can be indoors, outdoors, or a combination thereof. Embodiments use cooperative computer vision models to identify persons of interest, objects of interest, and both in media.

### BACKGROUND

Traditional computer vision systems frequently deliver limited success due to rapidly changing operating environments further complicated by insufficient data and time.

Current vision analytics platforms often share one or more limitations:

Reliance on a single model or support multiple models that run in parallel, resulting in a lack of precision when an intent is to trigger on an exact set of parameters.

Camera movement—whether due to wind or panning—disrupts video monitoring. Complex backgrounds, such as leaves, or branches, can also disrupt the ability to monitor and analyze foreground objects accurately.

High dependency on large amounts of training data to enable object or person detection possible. There's often not enough training data to adequately train computer vision systems, or the time generally required to train a traditional vision system are too constrained within mission parameters.

### BRIEF DESCRIPTION OF THE DRAWINGS

FIG. 1 illustrates, by way of example, a diagram of an embodiment of a system for surveillance using cooperative vision models.

FIG. 2 illustrates, by way of example, a diagram of an embodiment of a UI for cooperative model surveillance.

FIG. 3 illustrates, by way of example, a diagram of an embodiment of a UI that provides results of a mission that is completed or in progress.

FIG. 4 illustrates, by way of example, a diagram of an embodiment of a scene that helps illustrate missions.

FIG. 5 illustrates, by way of example, a diagram of an embodiment of a method for surveillance using cooperative computer vision models.

FIG. 6 is a block diagram of an example of an environment including a system for neural network (NN) training.

FIG. 7 illustrates, by way of example, a block diagram of an embodiment of a machine in the example form of a computer system within which instructions, for causing the machine to perform any one or more of the methods discussed herein, may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments provide a cooperative, multi-model vision analytics platform. Mission parameters can be defined to combine and leverage multiple vision models. Mission parameters include objects to be detected, faces to be detected, a confidence level associated with a positive result, an input media, among others. Vision models can include face recognition with named person identification, gait recognition, object detection, text-based parameter definitions (e.g. White pickup truck, Russian tank), or a combination thereof.

Embodiments can operate with little to no model training. Embodiments can leverage pre-trained models and one-shot detection. One-shot detection is a type of convolutional neural network (CNN) that reduces the amount of labeled training data used for learning how to identify objects and people. The amount of reduction is by more than 90%. The reduction substantially reduces compute overhead and time constraints.

Embodiments can operate in the cloud. Embodiments can support edge use cases. Embodiments can execute on artificial intelligence (AI) embedded systems, such as can include graphics processing units (GPUs), central processing units (CPUs), memory, power management, peripheral interfaces, a combination thereof, or the like.

Embodiments support analysis of individual images, recorded video, and livestreams (scalable to hundreds of simultaneous inputs). Missions can be built in seconds. Users can be added to any mission with the ability to share and collaborate on trigged events.

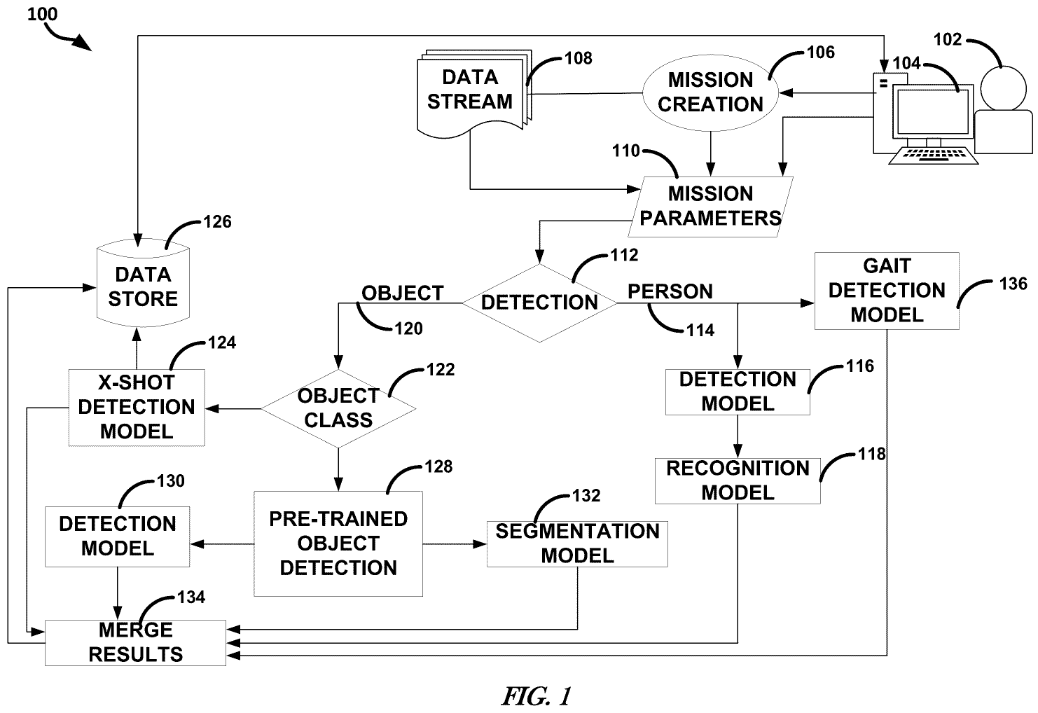

FIG. 1 illustrates, by way of example, a diagram of an embodiment of a system 100 for surveillance using cooperative vision models. The system 100 as illustrated includes models 116, 118, 124, 130, 132, 136 that cooperate to execute a mission. The mission is a detection of a person (e.g., via face recognition, gait recognition, or a combination thereof), an object (e.g., via detection, segmentation, or a combination thereof), or a combination thereof. The mission is created at operation 106. The operation 106 can include a user 102, through a user interface of a compute device 104, naming the mission, defining users that are allowed access to the mission, defining media input at operation 108, and defining mission parameters at operation 110. The compute device includes a smartphone, desktop computer, laptop computer, tablet, appliance, vehicle, or other device that has access to a network that provides access to the UI and the components of the system 100, such as through application programming interfaces (APIs). The user 102 accesses a user interface (UI) that exposes the user 102 to the mission creation operation 106, operation 108, operation 110, and results 134, among others.

The operation 108 includes the user 102 selecting a type of media and location of the media to be analyzed in executing the mission. The type of media can include one or more files, one or more universal resource locators (URLs) that host video or image data, one or more livestreams (e.g., from a camera on the same network as the compute device 104), or the like. The location of the media can be defined using a file path (e.g., for media on the same network as the compute device 104), a URL (e.g., for media on a network remote to the compute device 104), or the like.

The operation 110 can include the user 102 selecting, through the UI, the items to be detected. The items can include an object, person, a gait, or a combination thereof. The selection informs which models, of a cooperative group of models, will operate on the media to detect the items.

The operation 110 can include the user 102 selecting, through UI, a minimum confidence level associated with a positive identification. Any images (note that an individual video frame is considered an image herein) that include a classification that matches a specified item of the items and has a confidence level that is greater than (or equal to) the minimum confidence level will be returned as respective positive results.

The operation 110 can include the user 102 providing an image or other media of an item to be detected by the cooperative models. The media can be used by an X-shot (where X is a positive integer), object detection, object segmentation, person detection, face recognition, gait detection, or other model.

The operation 112 selects and schedules the models to execute on the specified media. If a person 114 is defined in the mission parameters at operation 110, the operation 112 selects and schedules the detection model 116. The detection model 116 is a pre-trained model that is configured to detect only people in images. Any images, or portions of images, classified, by the detection model 116, as including people can be provided to the recognition model 118. The portions of the images can include the pixels contained within bounds associated with a given classification instance. The bounds can include a bounding box, silhouette, bounding ellipse, or the like. Some detection models are segmentation models that classify individual pixels. The portions of the images can include contiguous pixels associated with the same specified class.

The recognition model 118 is trained to recognize a person specified at operation 110. The recognition model 118 can be pre-trained to detect faces of a number of people.

The gait detection model 136 is trained to detect gaits and recognize people based on their gaits. The gait detection model 136 can be pre-trained to detect gaits of a number of people.

Results of the recognition model 118, the gait detection model 136, or a combination thereof, can be provided to a merge results operation 134, a data store 126, or a combination thereof. The results of the recognition model 118 and gait detection model 136 include images that include the specified person, a time at which the images were collected, location at which the images were collected, camera that captured the images, an identifier that associates metadata with the image, a combination thereof, or the like. The time can be absolute (date (month, date, year, and time) or relative (an amount of time that has lapsed between a capture time of a first image analyzed in the mission to a capture time of the present image).

If an object 120 is defined in the mission parameters at operation 110, an operation 122 selects and schedules one or more object detection models 124, 130, 132 to operate on the media. If a specific object is to be detected, which can be indicated by the user 102 selecting X-shot detection and providing a reference image at operation 110, an X-shot detection model 124 can be selected and scheduled to execute on the media. The X-shot detection model 124 can include a Siamese Mask Region-based Convolutional Neural Network (MRCNN). Results of the X-shot detection model 124 can be provided to the operation 134, a data store 126, or a combination thereof.

If a specific object is not to be detected, which can be indicated by the user 102 not selecting X-shot detection and/or not providing a reference image at operation 110, one or more pre-trained object detection models can be selected and scheduled to operate on the media at operation 128. Pre-trained object detection models include the segmentation model 132 and the detection model 130, can be selected and scheduled to execute on the media.

The detection model 124 can include a pre-trained, general object detection model. Results of the detection model 124 can be provided to the operation 134, a data store 126, or a combination thereof.

The segmentation model 124 can include a pre-trained, general object segmentation model. Results of the segmentation model 124 can be provided to the operation 134, a data store 126, or a combination thereof.

As discussed previously, the segmentation model 124 provides a per-pixel classification for each of its inputs. Any segments (contiguous pixels) that are classified, including those that are classified as unknown (e.g., by an actual class of unknown or by a confidence below a threshold confidence) can be stored in the data store 126 and associated with their classification. Then, when the user 102 defines a mission that involves the media, the data store 126 can be queried for the media and classification and return the results that were pre-determined. If the user 102 provides a class that is not detected by the general object detection model 130 and the segmentation model 132, the image portions classified as unknown for the time segment can be analyzed by the X-shot detection model 124 for a match. This reduces future processing of the same media.

The merge results operation 134 can identify images that were determined, by one of the object detection models 124, 130, 132, to include the object 120 and, by the recognition model 118, to include the person 114. The merge results operation 134 can determine statistics for the results, such as an average confidence, a total number of images that include both the person and the object, or the like. The statistics can be per time segment. The time segment can be default or user-specified. The time segment can be defined in relative or absolute terms.

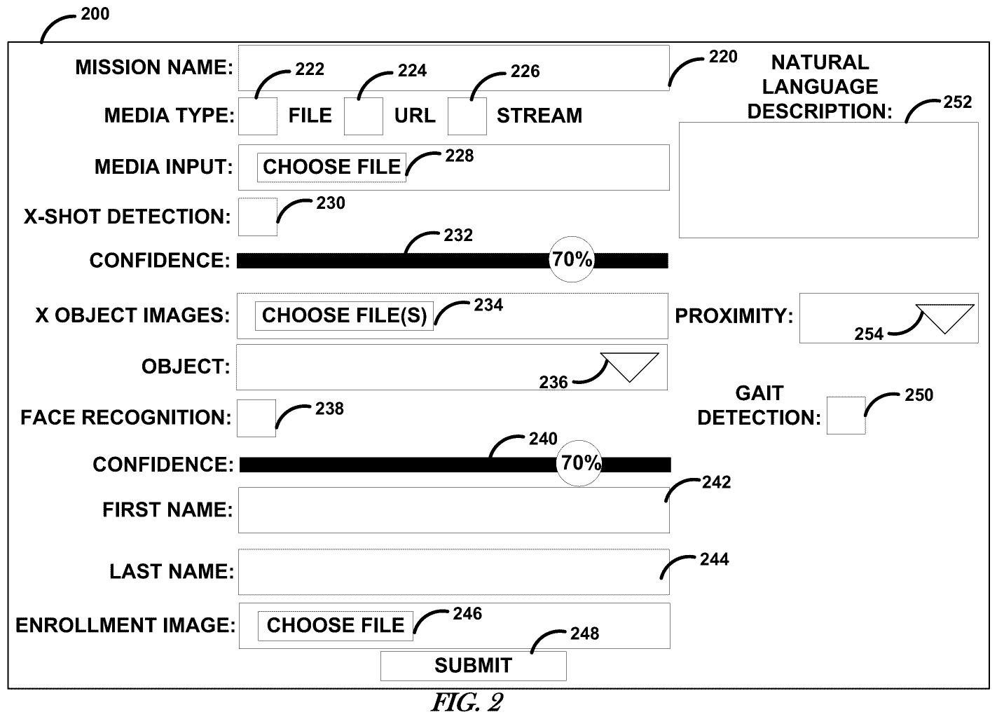

FIG. 2 illustrates, by way of example, a diagram of an embodiment of a UI 200 for cooperative model surveillance. The UI 200 can be presented to the user 102 via a display of the compute device 104. The user 102 can interact with the UI 200 via an input device (e.g., mouse, touchpad, keyboard, camera, microphone, or the like) of the compute device. The UI 200 includes software controls through which the user 102 interacts to configure and execute a mission. Software controls include text boxes, checkboxes, radio buttons, meus, dropdown lists, list boxes, buttons, toggles, slider bars, text fields, date field, breadcrumb, slider, search field, pagination, slider, tags, icons, tooltips, icons, progress bar, notifications, message boxes, modal windows, accordion, or the like. Different software controls can be used to achieve a same result. Thus, the software controls are only one example configuration for the UI and many other configurations are within the scope of embodiments.

The user 102 generates the mission by entering a mission name in the textbox 220. The user 102 can provide a natural language description of what is to be accomplished by the mission in a text box 252. The text in the text box 252 can indicate parameters of the mission that are or are not defined by other software controls of the UI 200. For example, the user 102 can indicate a color to be associated with an object, text of a license plate to be recognized, or other information that may not be expressly defined by the other software controls. An example input includes “Finding Alonzo Smith, last seen in white pickup truck with Colorado license plate CLOVER”.

The user 102 defines the data stream using checkboxes 222, 224, 226 and a media input list box 228. The checkbox 222, when selected, indicates that the mission is to classify a file. The checkbox 224, when selected, indicates that the mission is to classify media accessible through a website or other location remote from the network. The checkbox 226, when selected, indicates that the mission is to classify media output from a camera. The list box 228 allows the user to select media local to the network.

The user 102 defines the mission parameters by selecting or de-selecting checkboxes 230, 238, slider bars 232, 240, list boxes 234, 246, dropdown list 236, text boxes 242, 244, or a combination thereof. The checkbox 230, when selected, indicates that the X-shot detection model 124 is to be used for object detection. The user 102 indicates the minimum confidence at which a result from the X-shot detection model 124 is considered a positive result using the slider bar 232. The user 102 indicates one or more images of object to be used as reference images for the X-shot detection model 124 using the list box 234. The user 102 can select an object type using the dropdown list 236. By selecting the object type using the dropdown list 236, the user 102 indicates that one or more general object detection models 130, 132 are to be used to classify the indicated media.

The checkbox 238, when selected, indicates that the face detection model 116 and face recognition model 118 are to be used to classify the indicated media. The checkbox, when selected, indicates that the gait recognition model 250 is to be used to classify the indicated media. The user 102 indicates the minimum confidence at which a result from the face recognition model 118 and/or gait recognition model 136 is considered a positive result using the slider bar 240. The user 102 indicates the person associated with the face or gait to be recognized by a first name, entered into the text box 242, and a last name, entered into text box 244. The user 102 can provide an enrollment image using list box 246. The data store 126 can store images, including the enrollment image, of faces associated with the first name entered into the text box 242 and the last name entered into the text box 244.

The user 102 may desire that results only be provided when a defined object is proximate a defined person. The user 102 can enter a proximity value using dropdown list 254. The proximity can be in terms of distance in a same image, number of pixels in a same image, or the like. The user can thus define that a positive result is only images that include both the object and the image and also satisfy the proximity defined in the dropdown list 254.

After the user 102 is satisfied with the mission creation, data stream, and mission parameters, they can initiate mission execution by selecting a submit button 248. The mission then executes in accord with the data stream, and mission parameters defined through the UI 200. As the mission executes, results are stored in the data store 126 for later retrieval, analysis, and presentation by the compute device 104.

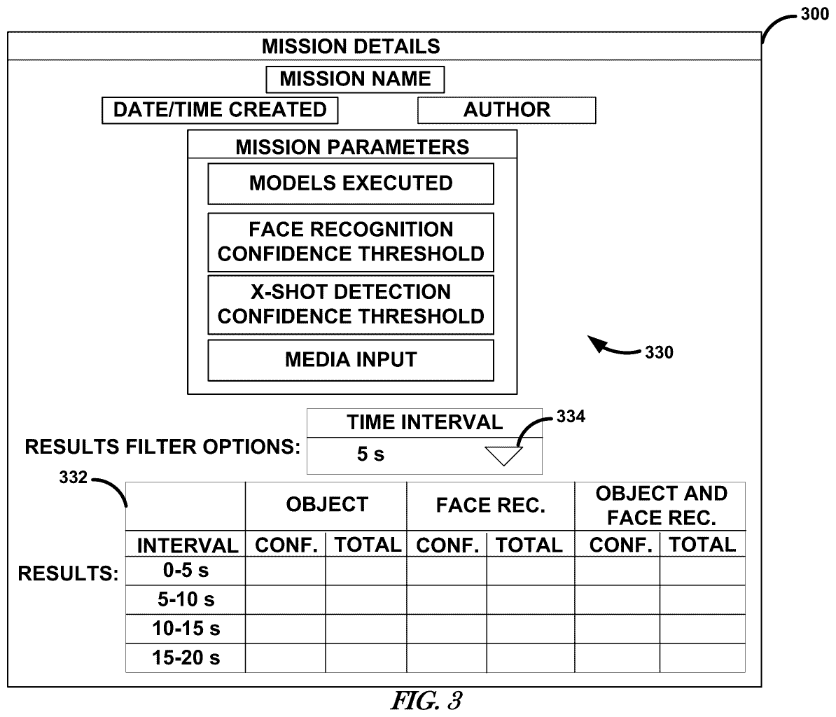

FIG. 3 illustrates, by way of example, a diagram of an embodiment of a UI 300 that provides results of a mission that is completed or in progress. The UI 300 provides a mission summary 330 and mission results 332. The mission summary 330 can detail the mission name, date/time the mission was created or launched, the user 102 that created the mission, mission parameters, a combination thereof, or the like. The mission parameters are those items specified at operation 110. The mission parameters can include names or types of the models executed by the mission, a face recognition confidence threshold, an X-shot detection confidence threshold, media classified by the models, a combination thereof, or the like.

The results 332 detail the classifications from the models that exceed the defined respective confidence threshold. The user 102 can alter a form of the results 332 using a dropdown list 334. The results 332 can indicate a timeframe, a model or models, a total number of images with positive results for the timeframe and the model or models, a combination thereof, or the like.

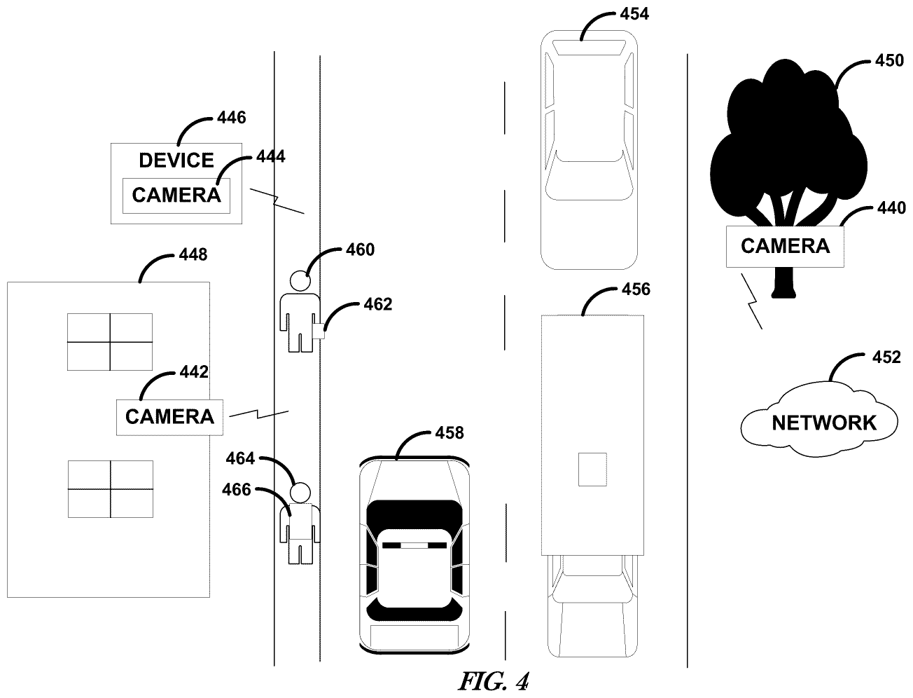

FIG. 4 illustrates, by way of example, a diagram of an embodiment of a scene that helps illustrate missions. The scene as illustrated includes people 460, 464, vehicles 454, 456, 458, cameras 440, 442, 444, and a network 452. The cameras 440, 442, 444 provide streams of video frames or images that can be used in cooperative model surveillance. One or more of the cameras 440, 442, 444 can be communicatively coupled to the network 452. The cameras 440, 442, 444 can communicate data indicating pixels and corresponding pixel values, time/date the values were captured, an identification of the camera 440, 442, 444 or a location of the camera 440, 442, 444, to the network 452. The network 452 can host or otherwise implement the system 100 to perform cooperative model surveillance.

The cameras 440, 442, 444 can be stationary or mobile. The example cameras 440, 442, 444 in FIG. 4 are mounted to a building 448, mounted to a tree 450, and part of a device 446. The device 446 can be mobile or stationary. The device can include a phone, autonomous vehicle, remote control vehicle, or the like.

The system 100 can be configured to implement a mission that includes identifying a specific person 460, 464 with a specific or general object 462, 466. Examples of objects are vast and too numerous to name in this application. Some example objects include stuff (amorphous or uncountable objects) or things (countable or objects with well-defined shapes). Example objects include sky, cloud, grass, tree, vegetation, building, person, bicycle, car, motorcycle, airplane, bus, train, truck, boat, traffic light, fire hydrant, stop sign, parking meter, bench, bird, cat, dog, horse, sheep, cow, elephant, bear, zebra, giraffe, backpack, umbrella, handbag, tie, suitcase, frisbee, skis, snowboard, sports ball, kite, baseball bat, baseball glove, skateboard, surfboard, tennis racket, bottle, wine glass, cup, fork, knife, spoon, bowl, banana, apple, sandwich, orange, broccoli, carrot, hot dog, pizza, donut, cake, chair, couch, potted plant, bed, dining table, toilet, tv, laptop, mouse, remote, keyboard, cell phone, microwave, oven, toaster, sink, refrigerator, book, clock, vase, scissors, teddy bear, hair drier, toothbrush.

A more specific example of a mission can include identifying a person in a vehicle in an image from one or more of the cameras 440, 442, 444; identifying a vehicle with a specific license plate in an image from one or more of the cameras 440, 442, 444; identifying a person and an object 462, 466 in a vehicle in video from one of the cameras 440, 442, 444; among many others.

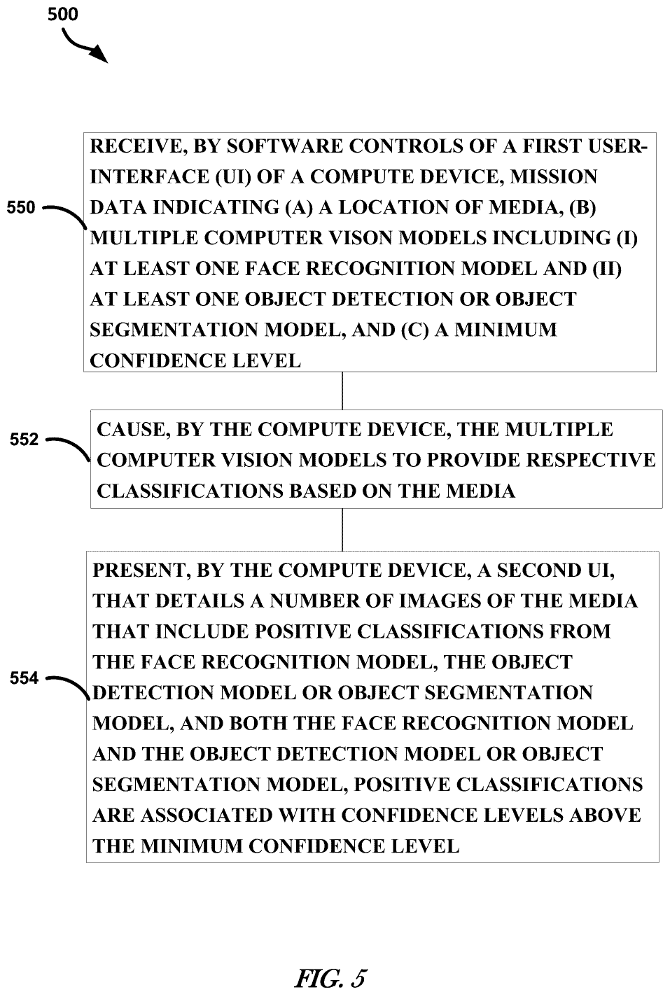

FIG. 5 illustrates, by way of example, a diagram of an embodiment of a method 500 for surveillance using cooperative computer vision models. The method 500 as illustrated includes receiving, by software controls of a first user-interface (UI) of a compute device, mission data indicating (a) a location of media, (b) multiple computer vison models including (i) at least one face recognition model and (ii) at least one object detection or object segmentation model, and (c) a minimum confidence level, at operation 550; causing, by the compute device, the multiple computer vision models to provide respective classifications based on the media, at operation 552; and presenting, by the compute device, a second UI, that details a number of images of the media that include positive classifications from the face recognition model, the object detection model or object segmentation model, and both the face recognition model and the object detection model or object segmentation model, positive classifications are associated with confidence levels above the minimum confidence level, at operation 554.

The mission data can specify a name of a person to be detected by the face recognition model and an object to be detected by the object detection model or the object segmentation model. The multiple computer vision models can further include a face detection model, a panoptic segmentation model, an object detection model, and an x-shot detection model. The multiple models can further include a face detection model, a face recognition model, and one of a panoptic segmentation model, an object detection model, or an x-shot detection model

The method 500 can further include receiving, by a software control of the second UI, data indicating a time range over which to aggregate the positive classifications. The mission data can specify a time frame associated with the media and the second UI presents the number of images for each time range in the time frame that include the positive classification. The mission data can (i) include an image of the object to be detected and (ii) indicate the x-shot detection model is to be executed based on the image. The mission data can further include proximity data defining a distance or number of pixels, and positive classifications include only images that include the object and the person within the distance or the number of pixels of each other.

Using the system 100, UI 200, 300, method 500, or a combination thereof, the user 102 can be informed of mission status and progress. The user 102 can, for example, be an enforcement officer (e.g., a police officer, a prison guard or other prison personnel, a federal officer, a security guard, or the like). The enforcement officer can observe the results of the mission presented by, for example, the UI 300. The results can be used to inform the enforcement officer of a location of an offender, whether the public is in danger, and the enforcement officer can take action to apprehend the offender, protect the public, or the like.

Embodiments provide a Web-based platform that can be deployed behind private networks or a native Cloud. Embodiments can also support edge computing devices. Embodiments can use two or more computer vision models that can be used separately or cooperatively: Siamese Mask R-CNN, face recognition, and panoptic scene segmentation. Each model can run against one, several, or all datasets.

### Siamese Mask R-CNN for One Shot Detection

Image and video segmentation enables extraction of meaningful information from visual data. The goal of image segmentation is to partition an image or video into regions of semantic importance, such as objects, backgrounds, or foregrounds. However, this task is challenging due to several factors, such as the lack of large and diverse datasets to train convolutional neural network (CNN) models and the presence of variations in lighting, perspective, and occlusions.

To address these challenges, the Siamese Mask Region-based Convolutional Neural Network (R-CNN), an advanced one-shot detection approach was developed in 2018. The Siamese Mask RCNN uses a CNN-based architecture to combine the power of two state-of-the-art models, a) Mask R-CNN and b) Siamese networks, and achieve high accuracy and efficiency in segmentation tasks. In embodiments of the Siamese Mask R-CNN, the model accepts two files as input—a reference image and a query file. The reference image is the baseline or ground truth image containing the object to be detected, and the query file is the image or video being compared to the reference image to identify similarities and detect objects. In the case of video query files, the video is divided into individual frames or images, and then processed as input to the model. The model then detects instances of the reference image in the query image or video frame, and returns an image or video frame object with the corresponding object masks and confidence labels annotated.

### Components of the Siamese Mask R-CNN

Siamese Network: A Siamese network is a neural network architecture that learns a similarity metric between two inputs. In the context of Siamese Mask R-CNN, the Siamese network learns a similarity metric between two images or frames from a video (here, a reference image and a query file). This similarity metric is used to find the corresponding object instances in the two images or frames.

Region Proposal Network (RPN): The RPN is a part of the Mask R-CNN architecture that generates a set of object proposals for each input image or frame. Object proposals are regions in the image or frame that are likely to contain an object. The RPN is trained using a binary classification task, where it predicts whether a given region contains an object or not.

Mask Head—The Mask Head is also part of the Mask R-CNN architecture that generates pixel-level segmentation masks for each object instance. The Mask Head accepts as input a feature map and a bounding box that encloses the object and outputs a binary mask that indicates if the pixels belong to the object or not.

Similarity Head—The Similarity Head is a part of the Siamese Mask R-CNN architecture that learns a similarity metric between two feature maps. It takes as input two feature maps, one from the reference image and the other from the query image or frame, and outputs a scalar value that indicates the similarity between them. This similarity metric is used to find the corresponding object instances in the two images or frames.

### Working of the Siamese Mask R-CNN

Given a reference image and query image or video frame as input, the Siamese network first learns a similarity metric between them. Next, the RPN generates object proposals for each query image or video frame. The Mask Head generates pixel-level segmentation masks for each object instance, while the Similarity Head learns a similarity metric between the feature maps of the reference and query inputs. The object instances in the reference and query inputs are matched based on their similarity scores. Finally, the segmentation masks are refined using a mask refinement module that takes into account the matching between the object instances.

### Scene Understanding Using Panoptic Image Segmentation

The Panoptic Segmentation task has renewed the computer vision community's interest in unifying the tasks of instance segmentation (for thing classes) and semantic segmentation (for stuff classes). However, current state-of-the-art methods for this joint task use separate and dissimilar networks for instance and semantic segmentation, without performing any shared computation. Panoptic segmentation endows Mask R-CNN, a popular instance segmentation method, with a semantic segmentation branch using a shared Feature Pyramid Network (FPN) backbone, which not only remains effective for instance segmentation, but also yields a lightweight, top performing method for semantic segmentation.

### Architecture of Panoptic FPN

Panoptic FPN, is a simple, single-network baseline whose goal is to achieve top performance on both instance and semantic segmentation, and their joint task: panoptic segmentation. The design principle is to start from Mask R-CNN with FPN, a strong instance segmentation baseline, and make minimal changes to also generate a semantic segmentation dense-pixel output.

Feature Pyramid Network: FPN takes a standard network with features at multiple spatial resolutions, and adds a light top-down pathway with lateral connections. The top-down pathway starts from the deepest layer of the network and progressively up-samples it while adding in transformed versions of higher-resolution features from the bottom-up pathway. FPN generates a pyramid, typically with scales from 1/32 to ¼ resolution, where each pyramid level has the same channel dimension.

Instance Segmentation branch: The design of FPN, and in particular the use of the same channel dimension for all pyramid levels, makes it easy to attach a region-based object detector like Faster R-CNN [9]. Faster R-CNN performs region of interest (RoI) pooling on different pyramid levels and applies a shared network branch to predict a refined box and class label for each region. To output instance segmentations, we use Mask R-CNN, which extends Faster R-CNN by adding a Feature Convolution Network (FCN) branch to predict a binary segmentation mask for each candidate region.

Semantic segmentation branch: To generate the semantic segmentation output from the FPN features, embodiments can merge the information from all levels of the FPN pyramid into a single output. Starting from the deepest FPN level (at 1/32 scale), perform three upsampling stages to yield a feature map at ¼ scale, where each upsampling stage consists of 3×3 convolution, group norm, ReLU, and 2× bilinear upsampling. This strategy is repeated for FPN scales 1/16, ⅛, and ¼ with progressively fewer upsampling stages). The result is a set of feature maps at the same ¼ scale, which are then element-wise summed. A final 1×1 convolution, 4× bilinear upsampling, and softmax are used to generate the per-pixel class labels at the original image resolution. In addition to stuff classes, this branch also outputs a special ‘other’ class for all pixels belonging to objects (to avoid predicting stuff classes for such pixels).

A simple scene understanding example of this approach, to object recognition that uses a single neural network to simultaneously recognize distinct foreground objects, such as animals or people (a task called instance segmentation), while also labeling pixels in the image background with classes, such as road, sky, or grass (a task called semantic segmentation).

### Working of Panoptic Image Segmentation

Given a reference image or a video sequence as an input to the Panoptic FPN network, the network first performs Mask R-CNN object detection using the instance segmentation branch which is an extension of Faster R-CNN. This candidate output region of interest (RoI) is then upsampled from the deepest layer, and adding feature transformations of higher transformation resolution which creates a feature-pyramid from its bottom-up pathway with same dimensions all across. Next, the semantic segmentation branch combines all the outputs of FPN layers into a single output of dense feature map, that is summed element-wise, resulting in an overall output of frames or images that are both instance and semantically segmented using one shared network.

### Face Recognition

Facial Recognition in the wild is an open problem in computer vision that has a dual goal while recognizing faces: to maximize similarity between different images of the same face, and to minimize similarity between different faces. This creates a challenge for creating an efficient model that can accomplish this task, since theoretically an N-dimensional model can be used to recognize N faces, but that is self-defeating in the context of recognizing faces in the wild.

To address this challenge, we are designing a 2 stage pipeline to detect and identify faces in a video stream. The pipeline is designed to recognize as many faces in every frame of the video stream as possible, and can then focus on a single person of interest. This, combined with other models used in the project, increases the confidence in identifying a person of interest in a video stream by looking at other aspects like driving a particular car, or carrying a particular bag.

### Components of Face Recognition Pipeline

The first component is for Face Detection, responsible for detecting, aligning and rescaling the image so that the face is “angled straight” and is of the ideal resolution for the next stage in the pipeline. For this, we use the Face Mesh architecture from Mediapipe, that first detects all faces in the image using the BlazeFace model, and then for each face gives up to 468 3D landmarks on the face using an end-to-end neural network designed to detect 3D facial surface geometry. Both these models are designed to run on monocular video and on mobile GPUs, meaning they can be extended on client devices locally if needed, and can be run using a single camera without losing 3D depth information. The second Face Vectorization component is designed to reduce the image of a person's face into a 128D vector that represents the identity of the face, where images of the same person are mapped close together, and images of different faces are mapped far apart.

### Model Architecture

BlazeFace model: It is designed to be fast by prioritizing fewer and larger convolutional layers (5×5 filters) over more but smaller layers (3×3 followed by 1×1). They have also considered the fixed cost of forward-propagating through convolutional layers, specifically in GPU architectures. They hence created BlazeBlocks for feature extraction, which is a modified residual block which uses 5×5 filters followed by 1×1, and then concatenated with a max polling residual connection. The neural network includes 5 BlazeBlocks and 6 double BlazeBlocks (double stacked conv layers before activation) and the spatial resolution is bottlenecked at 8×8 (as opposed to the common 1×1 in MobileNet-inspired models).

3D landmark model: It has a similar architecture but uses a more simplified version of the BlazeBlocks closer to a typical residual network. The model is able to build mesh over an occluded face as well, which implies that the model can extract high-level as well as low-level mesh representations. IOD-normalized mean absolute distance between their annotations of the same image was recorded at ˜2.56%.

Face Vectorization: For this, an altered version of the ResNet-34 model proposed in which contains 29 layers instead of 34, and has half the number of filters per layer was used. This model was trained on multiple different datasets curated manually to end up with a training set of just less than 7500 faces. The resulting model obtains a mean error of 0.993833 with a standard deviation of 0.00272732 on the LFW benchmark.

### Multi Model Collaboration

Embodiments solve the problem of identifying a person of interest in a sea of footage recorded in the wild. “In The Wild” refers to content (photos, videos, etc.) recorded in an uncontrolled setting that can have variations across multiple conditions like distance from subject, angle of camera, lighting, occlusion of subject via still or moving objects, among others.

For a complex problem like this, it is important to consider multiple confirmations of detection across different models to be confident that the person of interest is in fact the one being detected by the system. The

Embodiments can gather results from the Face Recognition pipeline as well as the Siamese One-Shot Detection, Gait Recognition model, Panoptic Segmentation model, or a combination thereof, such as to increase the confidence further.

Panoptic Segmentation can be the first step in isolating items of interest in an image (and by extension on video streams). It can be used to isolate people and objects in a fairly busy frame, for example from CCTV camera footage. Once this position in the image is extracted, the next models can be used to perform identification of specific persons or objects. This reduces the search space for the Face Recognition pipeline, thus improving the probability of a positive detection. Since Panoptic can segment objects in a similar way, it can also be used to enhance the Siamese One-Shot Detection, by reducing its number of false positives.

The Face Recognition pipeline is designed to compare each face with a database of existing entries. Hence, in order to identify a particular person of interest, the system requires at least one mugshot image of the person to “register” them and when the pipeline runs on the video stream, it checks for this person of interest as well. The pipeline can also perform an isolated search so as to avoid identification of other persons and provide focus on relevant identification only.

The Siamese One-Shot detection model can be used as an enhancement step that helps zero in on the person of interest by adding the ability to identify a particular object that may be associated with the person, like holding a backpack or duffel bag. A preliminary approach to use this information is to build a pixel proximity metric that can be used to flag person identifications that are also near specific target objects. This can then be combined with relatively minimal human intervention to validate such identifications. Such a pixel proximity metric can also help in removing overlapping detections for a cleaner and more confident identification.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as object recognition, device behavior modeling (as in the present application) or the like. The models 116, 118, 124, 130, 132, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights. Note that the models 116, 118, 124, 130, 132 can be pre-trained from the perspective of the user 102.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

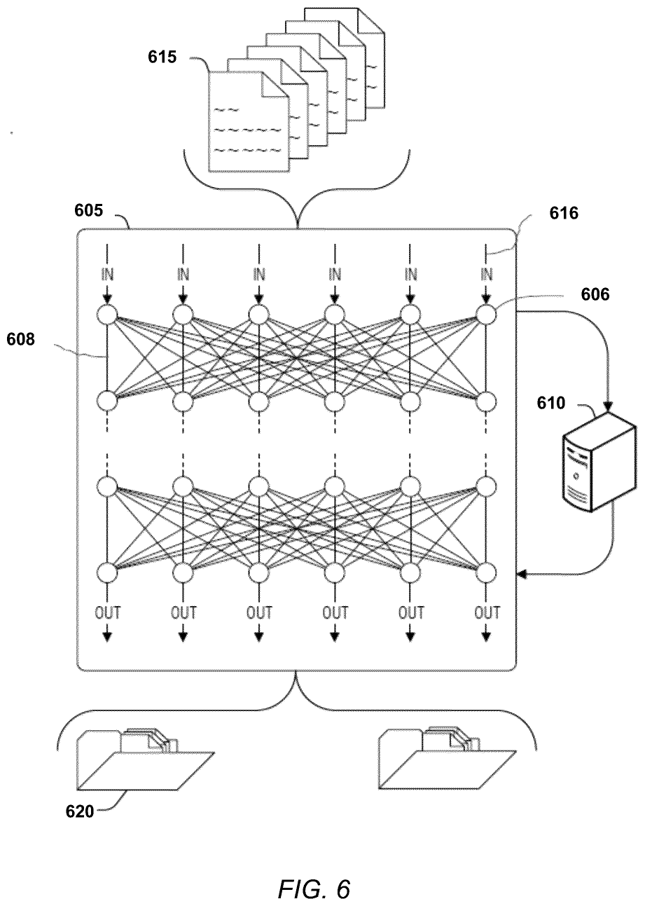

FIG. 6 is a block diagram of an example of an environment including a system for neural network (NN) training. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 607 within layers. Thus, a set of processing nodes 610 is arranged to perform the training of the ANN 605. The models 116, 118, 130, 132 can be trained using the system.

The set of processing nodes 610 is arranged to receive a training set 615 for the ANN 605. The ANN 605 comprises a set of nodes 607 arranged in layers (illustrated as rows of nodes 607) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as an image feature, or the like. Each value of the training or input 617 to be classified after ANN 605 is trained, is provided to a corresponding node 607 in the first layer or input layer of ANN 605. The values propagate through the layers and are changed by the objective function.

As noted, the set of processing nodes is arranged to train the neural network to create a trained neural network. After the ANN is trained, data input into the ANN will produce valid classifications 620 (e.g., the input data 617 will be assigned into categories), for example. The training performed by the set of processing nodes 607 is iterative. In an example, each iteration of the training the ANN 605 is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 607 (e.g., neurons) are trained independently. In an example, the nodes are trained on different hardware.

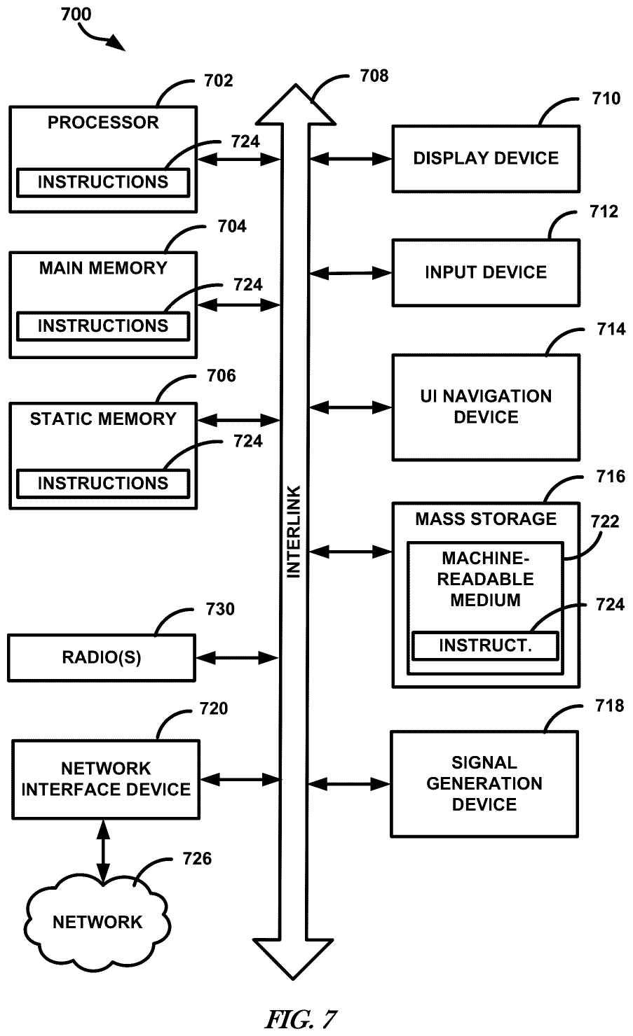

FIG. 7 illustrates, by way of example, a block diagram of an embodiment of a machine in the example form of a computer system 700 within which instructions, for causing the machine to perform any one or more of the methods discussed herein, may be executed. One or more of the models 116, 118, 124, 130, 132, operations 106, 108, 110, 112, 122, 128, 134, UI 200, 300, compute device 104, method 500, training system of FIG. 6, or other device, component, operation, or method discussed can include, or be implemented or performed by one or more of the components of the computer system 700. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a mass storage unit 716, a signal generation device 718 (e.g., a speaker), a network interface device 720, and a radio 730 such as Bluetooth, WWAN, WLAN, and NFC, permitting the application of security controls on such protocols.

The mass storage unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### ADDITIONAL NOTES AND EXAMPLES

Example 1 includes a method for surveillance using cooperative computer vision models, the method comprising receiving, by software controls of a first user-interface (UI) of a compute device, mission data indicating (a) a location of media, (b) multiple computer vison models including (i) at least one face recognition model and (ii) at least one object detection or object segmentation model, and (c) a minimum confidence level, causing, by the compute device, the multiple computer vision models to provide respective classifications based on the media, and presenting, by the compute device, a second UI, that details a number of images of the media that include positive classifications from the face recognition model, the object detection model or object segmentation model, and both the face recognition model and the object detection model or object segmentation model, positive classifications are associated with confidence levels above the minimum confidence level.

In Example 2, Example 1 further includes, wherein the mission data specifies a name of a person to be detected by the face recognition model and an object to be detected by the object detection model or the object segmentation model.

In Example 3 at least one of Examples 1-2 further includes, wherein the multiple computer vision models further include a face detection model, a panoptic segmentation model, an object detection model, and an x-shot detection model.

In Example 4, Example 3 further includes, wherein the multiple models further include a face detection model, a face recognition model, and one of a panoptic segmentation model, an object detection model, or an x-shot detection model.

In Example 5, at least one of Examples 1-5 further includes receiving, by a software control of the second UI, data indicating a time range over which to aggregate the positive classifications, and wherein the mission data specifies a time frame associated with the media and the second UI presents the number of images for each time range in the time frame that include the positive classification.

In Example 6, at least one of Examples 4-5 further includes, wherein the mission data (i) includes an image of the object to be detected and (ii) indicates the x-shot detection model is to be executed based on the image.

In Example 7, at least one of Examples 1-6 further includes, wherein the mission data further includes proximity data defining a distance or number of pixels, and positive classifications include only images that include the object and the person within the distance or the number of pixels of each other.

Example 8 includes a non-transitory machine-readable medium including instructions that, when executed by a machine, cause the machine to perform the method of at least one of Examples 1-7.

Example 9 includes a system for machine learning (ML) training dataset generation, the system comprising processing circuitry and a memory including instructions that, when executed by the processing circuitry, cause the processing circuitry to perform the method of at least one of Examples 1-7.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for surveillance using cooperative computer vision models, the method comprising:
receiving, by software controls of a first user-interface (UI) of a compute device, mission data indicating (a) a location of media, (b) multiple computer vison models including (i) at least one face recognition model and (ii) at least one object detection or object segmentation model, and (c) a minimum confidence level;
causing, by the compute device, the multiple computer vision models to provide respective classifications based on the media; and
presenting, by the compute device, a second UI, that details a number of images of the media that include positive classifications from the face recognition model, the object detection model or object segmentation model, and both the face recognition model and the object detection model or object segmentation model, positive classifications are associated with confidence levels above the minimum confidence level.

2. The method of claim 1, wherein the mission data specifies a name of a person to be detected by the face recognition model and an object to be detected by the object detection model or the object segmentation model.

3. The method of claim 1, wherein the multiple computer vision models further include a face detection model, a panoptic segmentation model, an object detection model, and an x-shot detection model.

4. The method of claim 3, wherein the multiple models further include a face detection model, a face recognition model, and one of a panoptic segmentation model, an object detection model, or an x-shot detection model.

5. The method of claim 1, further comprising:
receiving, by a software control of the second UI, data indicating a time range over which to aggregate the positive classifications; and
wherein the mission data specifies a time frame associated with the media and the second UI presents the number of images for each time range in the time frame that include the positive classification.

6. The method of claim 4, wherein the mission data (i) includes an image of the object to be detected and (ii) indicates the x-shot detection model is to be executed based on the image.

7. The method of claim 2, wherein the mission data further includes proximity data defining a distance or number of pixels, and positive classifications include only images that include the object and the person within the distance or the number of pixels of each other.

8. A non-transitory machine-readable medium including instructions that, when executed by a machine, cause the machine to perform operations for surveillance using cooperative computer vision models, the operations comprising:
receiving, by software controls of a first user-interface (UI) of a compute device, mission data indicating (a) a location of media, (b) multiple computer vison models including (i) at least one face recognition model and (ii) at least one object detection or object segmentation model, and (c) a minimum confidence level;
causing, by the compute device, the multiple computer vision models to provide respective classifications based on the media; and
presenting, by the compute device, a second UI, that details a number of images of the media that include positive classifications from the face recognition model, the object detection model or object segmentation model, and both the face recognition model and the object detection model or object segmentation model, positive classifications are associated with confidence levels above the minimum confidence level.

9. The non-transitory machine-readable medium of claim 8, wherein the mission data specifies a name of a person to be detected by the face recognition model and an object to be detected by the object detection model or the object segmentation model.

10. The non-transitory machine-readable medium of claim 8, wherein the multiple computer vision models further include a face detection model, a panoptic segmentation model, an object detection model, and an x-shot detection model.

11. The non-transitory machine-readable medium of claim 10, wherein the multiple models further include a face detection model, a face recognition model, and one of a panoptic segmentation model, an object detection model, or an x-shot detection model.

12. The non-transitory machine-readable medium of claim 8, wherein the operations further comprise:
receiving, by a software control of the second UI, data indicating a time range over which to aggregate the positive classifications; and
wherein the mission data specifies a time frame associated with the media and the second UI presents the number of images for each time range in the time frame that include the positive classification.

13. The non-transitory machine-readable medium of claim 11, wherein the mission data (i) includes an image of the object to be detected and (ii) indicates the x-shot detection model is to be executed based on the image.

14. The non-transitory machine-readable medium of claim 9, wherein the mission data further includes proximity data defining a distance or number of pixels, and positive classifications include only images that include the object and the person within the distance or the number of pixels of each other.

15. A system for surveillance using cooperative computer vision models, the system comprising:
a first user interface (UI) with software controls, the first UI configured to receive, by the software controls, mission data indicating (a) a location of media, (b) multiple computer vison models including (i) at least one face recognition model and (ii) at least one object detection or object segmentation model, and (c) a minimum confidence level;
multiple computer vision models coupled to provide respective classifications based on the media; and
a display configured to present a second UI that details a number of images of the media that include positive classifications from the face recognition model, the object detection model or object segmentation model, and both the face recognition model and the object detection model or object segmentation model, positive classifications are associated with confidence levels above the minimum confidence level.

16. The system of claim 15, wherein the mission data specifies a name of a person to be detected by the face recognition model and an object to be detected by the object detection model or the object segmentation model.

17. The system of claim 15, wherein the multiple computer vision models further include a face detection model, a panoptic segmentation model, an object detection model, and an x-shot detection model.

18. The system of claim 17, wherein the multiple models further include a face detection model, a face recognition model, and one of a panoptic segmentation model, an object detection model, or an x-shot detection model.

19. The system of claim 15, wherein a software control of the second UI is configured to receive data indicating a time range over which to aggregate the positive classifications; and
wherein the mission data specifies a time frame associated with the media and the second UI presents the number of images for each time range in the time frame that include the positive classification.

20. The system of claim 18, wherein the mission data (i) includes an image of the object to be detected and (ii) indicates the x-shot detection model is to be executed based on the image.
